(19) United States
(12) Patent Application Publication
(10) Pub. No.: US 2002/0074493 A1
(43) Pub. Date: Jun. 20, 2002

(54) Multiple-source arrays for confocal and near-field microscopy

(76) Inventors: Henry A. Hill, Tucson, AZ (US); Kyle B. Ferrio, Wilmington, NC (US)

Correspondence Address: ERIC L. PRAHL, Fish & Richardson P.C., 225 Franklin Street, Boston, MA, 02110-2804, US

(21) Appl. No.: 09/917,402

(22) Filed: Jul. 27, 2001

Related U.S. Application Data
(60) Provisional application No. 60/221,019, filed on Jul. 27, 2000.

(51) Int. Cl. G01N 23/00

(52) U.S. Cl. 250/306

(57) ABSTRACT

A multiple-source array for illuminating an object including: a source of electromagnetic radiation having a wavelength λ in vacuum; and a reflective mask positioned to receive the electromagnetic radiation, the reflective mask comprising an array of spatially separated apertures, wherein each aperture comprises a dielectric material defining a waveguide having transverse dimensions sufficient to support one or more guided propagating modes of the electromagnetic radiation extending through the mask, each aperture configured to radiate a portion of the electromagnetic radiation to the object.

### CROSS-REFERENCE TO RELATED APPLICATIONS

This application claims priority from provisional application Serial No. 60/221,019 filed Jul. 27, 2000 by Henry A. Hill entitled “Multiple-Source Arrays for Confocal and Near-Field Microscopy,” the contents of which is incorporated herein by reference.

### BACKGROUND OF THE INVENTION

The invention relates to a class of novel mask structures that can provide utilitarian improvements to the speed, signal-to-noise ratio and measurement bandwidth of scanning microscopy.

Scanning microscopy techniques, including near-field and confocal scanning microscopy, conventionally employ a single spatially localized detection or excitation element, sometimes known as the scanning probe. The near-field scanning probe is typically a sub-wavelength aperture positioned in close proximity to a sample; in this way, sub-wavelength spatial resolution in the object-plane is obtained. The confocal scanning probe employs diffraction-limited optics to achieve resolution of the order of the optical wavelength. Spatially extended images are acquired by driving the scanning probe in a raster pattern. Near-field microscopy conventionally produces two-dimensional images in this manner. Confocal microscopy has the additional capability of imaging volumes by extending the raster scan into a third dimension, depth. Near-field and confocal scanning microscopy instruments typically achieve high spatial resolution via the use of a single effective aperture to select a small area or volume of the object plane or object. Unfortunately, transmission through the aperture is typically small, thereby taxing optical detection hardware and often requiring long measurement integration times.

### SUMMARY OF THE INVENTION

The present invention features a class of novel mask structures applicable to techniques broadly known as scanning microscopy. For example, embodiments provide for a plurality of arrangements of a plurality of apertures with high optical throughput, with the capacity to effect utilitarian improvements to the speed, signal-to-noise ratio and measurement bandwidth. Such embodiments may be incorporated into microscopy systems designed to investigate the profile of a sample, to read optical date from a sample, and/or write optical date to a sample.

In general, in one aspect, the invention features a multiple-source array for illuminating an object. The multiple source array includes: a source of electromagnetic radiation having a wavelength λ in vacuum; and a reflective mask positioned to receive the electromagnetic radiation. The reflective mask includes an array of spatially separated apertures. Each aperture includes a dielectric material defining a waveguide having transverse dimensions sufficient to support one or more guided propagating modes of the electromagnetic radiation extending through the mask. Furthermore each aperture configured to radiate a portion of the electromagnetic radiation to the object.

Embodiments of the multiple source array may include any of the following features.

The reflective mask may further include a reflective dielectric stack surrounding the array of apertures. For example, the reflective dielectric stack may include alternating layers of different dielectric materials. The refractive indices of the dielectric materials in the alternating layers may be smaller than the refractive index of the dielectric material in each aperture. The reflective mask may further includes a reflective/absorbing layer (e.g., a metal layer) positioned to attenuate evanescent components of the guided propagating modes extending away from the apertures. The reflective/absorbing layer typically has a thickness greater than the skin depth of the electromagnetic radiation for the reflective/absorbing layer material. The reflective/absorbing layer may positioned on one side of the dielectric stack. Alternatively, the reflective mask may further include a dielectric screening layer, and the reflective/absorbing layer is positioned between the dielectric screening layer and the dielectric stack. Furthermore, the reflective/absorbing layer may be formed by a series of pads in a common plane, wherein adjacent pads are spaced from one another by an amount sufficient to suppress plasmon oscillations in the reflective/absorbing layer.

The mask may further include an end mask portion positioned adjacent the object. Each aperture further includes a secondary aperture formed in the end mask portion and aligned with the corresponding waveguide. Each secondary aperture has a transverse dimension smaller than the transverse dimensions of the corresponding waveguide. Furthermore, the transverse dimension of each secondary aperture may be smaller than the vacuum wavelength of the electromagnetic radiation provided by the source. In addition, the mask may further include a reflective dielectric stack surrounding each of the waveguides. The end mask portion may include a metal layer. Also, each waveguide may define an optical cavity between opposite sides of the mask, and wherein the length of each waveguide is selected to cause the optical cavity to be resonant with the electromagnetic radiation.

The reflective mask may further includes an antireflection coating positioned adjacent the object.

At least some of the apertures may be substantially cylindrical and the cylindrical apertures may have a diameter on the order of λ/2n₃, where n₃ is the refractive index of the dielectric material in each corresponding aperture.

At least one of the transverse dimensions of each aperture may be on the order of λ/2n₃, where n₃ is the refractive index of the dielectric material in each corresponding aperture. Furthermore, another of the transverse dimensions of at least one of the apertures is smaller than λ/2n₃.

At least some of the apertures in the reflecting mask may define a periodic array. For example, the periodic array may include a multi-aperture basis.

The apertures may include a first set of apertures having properties sufficient to support a first set of one or more guided propagating modes of the electromagnetic radiation extending through the mask and a second set of apertures having properties sufficient to support a second set of one or more guided propagating modes of the electromagnetic radiation extending through the mask, wherein the first set of one or more guided propagating modes differs from the second set of one or more guided propagating modes. For example, the first set of apertures may define a first periodic array of apertures and the second set of apertures may define a second period array of apertures.

The dielectric material in at least one of the apertures may be silicon.

The wavelength λ provided by the source may be an optical wavelength.

The source may direct the electromagnetic radiation to contact the reflective mask at an angle with respect to a normal axis for the mask.

The source may direct the electromagnetic radiation to contact the reflective mask as a standing wave pattern.

The multiple source array may further include an optical substrate attached to the reflective mask, wherein the optical substrate is substantially transparent to the electromagnetic radiation. For example, the optical substrate may provide mechanical stability to the reflective mask. Furthermore, the optical substrate may include a curved surface to provide light gathering or focusing.

The multiple source array may further include a uniform dielectric layer formed over the reflective mask, wherein the dielectric material in the apertures and the dielectric layer formed over the mask include a common dielectric material. Furthermore, there may be an anti-reflection coating formed over the uniform dielectric layer.

In general, in another aspect, the invention features a multiple-source array for illuminating an object with electromagnetic radiation having a wavelength λ in vacuum. The multiple-source array includes a reflective mask including an array of spatially separated apertures. Each aperture includes a dielectric material defining a waveguide having transverse dimensions sufficient to support one or more guided propagating modes of the electromagnetic radiation extending through the mask. Furthermore, each aperture is configured to radiate a portion of the electromagnetic radiation to the object. Feature of the multiple-source array may include any of those described above.

In general, in another aspect, the invention features a method for illuminating an object with electromagnetic radiation having a wavelength λ in vacuum. The method including: providing a mask including an array of waveguides; and coupling a portion of the electromagnetic radiation through each waveguide to illuminate different spatial regions of the object. The method may further include features corresponding to any of those described above in connection with the multiple-source arrays.

Any of the embodiments may be incorporated into the confocal and near-field confocal, microscopy systems described in the following, commonly owned provisional applications: Serial No. 09/631,230 filed Aug. 2, 2000 by Henry A. Hill entitled “Scanning Interferometric Near-Field Confocal Microscopy,” and the corresponding PCT Publication WO 01/09662 A2 published Feb. 8, 2001; Provisional application Serial No. 60/221,091 filed Jul. 27, 2000 by Henry A. Hill entitled “Multiple-Source Arrays with Optical Transmission Enhanced by Resonant Cavities,” and the corresponding Utility Application Serial No.______ having the same title filed on Jul. 27, 2001; Provisional Application Serial No. 60,221,086 filed Jul. 27, 2000 by Henry A. Hill entitled “Scanning Interferometric Near-Field Confocal Microscopy with Background Amplitude Reduction and Compensation” and the corresponding Utility Application Serial No. ______ having the same title filed on Jul. 27, 2001; Provisional Application Serial No. 60/221,287 by Henry A. Hill filed Jul. 27, 2000 entitled “Control of Position and Orientation of Sub-Wavelength Aperture Array in Near-field Scanning Microscopy” and the corresponding Utility Application Serial No. ______ having the same title filed on Jul. 27, 2001; and Provisional Application Serial No. 60/221,295 by Henry A. Hill filed Jul. 27, 2000 entitled “Differential Interferometric Confocal Near-Field Microscopy” and the corresponding Utility Application Serial No. ______ having the same title filed on Jul. 27, 2001; the contents of each of the preceding applications being incorporated herein by reference. Aspects and features disclosed in the preceding provisional applications may be incorporated into the embodiments described in the present application.

Embodiments of the invention may include any of the following advantages.

One advantage is sub-wavelength spatial resolution in the object-plane, measured with respect to the vacuum-wavelength of an operating light source.

Another advantage is the use of a dielectric stack to provide a highly reflective mask surrounding the apertures. As a result, the reflective mask may used as one of multiple optics forming an optical cavity used to enhance the radiation energy on one side of the mask. In turn, the aperture waveguide couples radiation from the optical cavity to the opposite side of dielectric stack.

Another advantage is the ability to achieve high optical throughput for object-plane resolutions comparable to the resolution of conventional near-field microscopy.

Another advantage is an aperture array with the capability to acquire many image points simultaneously for high data-rate end-uses.

Another advantage is the capacity to bring many nominally identical scanning probes into uniformly controlled proximity to an object-plane.

Another advantage is a high degree of immunity to external mechanical disturbances.

Another advantage is the use of multiple near-field mode-structures not directly utilized by conventional near-field microscopy.

Another advantage is the ability to combine multiple types of scanning probes, each possessing properties tailored for a particular end-use, on a single platform in a planar geometry.

Another advantage is the integration of the aperture array with a supporting optical substrate which may be further figured to provide optical focusing or collection functions.

Another advantage is a method to further improve spatial resolution with the use of one or more absorbing or reflecting interlayer masks.

Another advantage is a method to suppress spurious or undesired interactions between the aperture array and materials in or near the object plane.

Another advantage is a method to suppress plasmon effects affecting certain aperture arrays.

Another advantage is operation in a traveling-wave-excitation modality for simultaneous optical transmission through an array of apertures.

Another advantage is operation in a phased-array modality.

Another advantage is operation in a mode-matched standing-wave-excitation modality for enhanced optical throughput through an array of simultaneously excited apertures.

Another advantage is the variable and selective excitation of periodic subsets of apertures in a standing-wave-excitation modality by tuning the periodicity of a standing wave pattern.

Another advantage is the variable and selective excitation of periodic subsets of apertures in a standing-wave-excitation modality by spatial rotation of a standing-wave pattern.

Another advantage is the combination of two or more aperture arrays variably and selectively excitable in a traveling-wave or standing-wave modality incorporating any of the fifteenth or sixteenth advantages.

Another advantage is the capacity to integrate anti-reflection and mode-matching structures directly into the aperture arrays to effect optimal transmission efficiency of the aperture arrays.

For convenience, the embodiments that follow are described with reference to electromagnetic radiation at optical wavelengths. Further embodiments at other wavelengths are also within the scope of the invention.

Other features, aspects, and advantages follow.

### BRIEF DESCRIPTION OF THE DRAWINGS

In the drawings, wherein like reference characters denote similar elements throughout the several views:

FIG. 1A, FIG. 1B, FIG. 1C, FIG. 1D and FIG. 1E illustrate, in schematic form, the presently preferred first embodiment of the instant invention, including a general conception of dielectric apertures (FIG. 1A) arranged on a two-dimensional lattice and the non-limiting example of circular dielectric apertures arranged on a two-dimensional lattice (FIG. 1B), each incorporated into an otherwise highly reflective planar mask; one-dimensional arrays (FIG. 1C and FIG. 1D) are shown to be a special case of two-dimensional arrays; arbitrary arrangements of dielectric apertures (FIG. 1E) are shown to be special cases of one-dimensional or two-dimensional arrays;

FIG. 2 illustrates, in schematic form, the construction of a typical dielectric aperture in an otherwise highly reflective planar mask and as such illustrates several aspects of the presently preferred first embodiment;

FIG. 3A, FIG. 3B and FIG. 3C illustrate, in schematic form, three fabrication methods which may be employed to effect in part the realization of the instant invention;

FIG. 4 illustrates, in schematic form, the presently preferred second embodiment of the instant invention, comprising a generalization of the presently preferred first embodiment to include multiple kinds of circular dielectric apertures forming a basis to be repeated on a lattice;

FIG. 5 illustrates, in schematic form, the presently preferred third embodiment of the instant invention, including rectangular dielectric apertures arranged on a lattice;

FIG. 6 illustrates, in schematic form, the presently preferred fourth embodiment of the instant invention, comprising a generalization of the presently preferred third embodiment to include multiple kinds of rectangular dielectric apertures forming a basis to be repeated on a lattice;

FIG. 7 illustrates, in schematic form, the presently preferred fifth embodiment of the instant invention, comprising a generalization of the presently preferred second and fourth embodiments to include multiple kinds of dielectric apertures including circular dielectric apertures and rectangular dielectric apertures forming a basis to be repeated on a lattice;

FIG. 8A and FIG. 8B illustrate, in schematic form, the presently preferred sixth embodiment of the instant invention, incorporating the presently preferred first through fifth embodiments, inclusive, and an absorbing or reflecting interlayer to improve spatial resolution with minimized interaction between the aperture array and materials in or near the object plane;

FIG. 9A and FIG. 9B illustrate, in schematic form, the presently preferred seventh embodiment of the instant invention, an adaptation of the presently preferred sixth embodiment to reduce coupling between members of the aperture array;

FIG. 10A and FIG. 10B illustrate, in schematic form, the presently preferred eighth embodiment of the instant invention, describing the combination of any of presently preferred first through seventh embodiments, inclusive, with an optical substrate;

FIG. 11 illustrates, in schematic form, the presently preferred ninth embodiment {KBF} of the instant invention, describing operation of the presently preferred eighth embodiment with a traveling wave to produce optical fields on the output side of an aperture array, including options to produce phased array outputs;

FIG. 12 illustrates, in schematic form, the presently preferred tenth embodiment of the instant invention, describing operation of the presently preferred eighth embodiment with a standing wave to produce enhanced optical fields on the output side of an aperture array, including options to selectively excite subsets of the aperture array;

FIG. 13 illustrates, in schematic form, the presently preferred eleventh embodiment of the instant invention, an adaptation of the presently preferred tenth embodiment to include multiple aperture arrays on a single otherwise highly reflecting mask;

FIG. 14A and FIG. 14B illustrate, in schematic form, the presently preferred twelfth embodiment of the instant invention, an adaptation of the presently preferred sixth embodiment of simplified design and construction; and

FIG. 15 illustrates, in schematic form, the presently preferred thirteenth embodiment of the instant invention, an adaptation of presently preferred first through fourteenth embodiments, inclusive, including an integral anti-reflection structure and an integral mode-matching structure.

FIG. 16A and FIG. 16B illustrate, in schematic form, additional embodiments of the invention in which an end mask portion provides at least one secondary aperture to further increase the spatial resolution of the source array.

### DETAILED DESCRIPTION OF THE INVENTION

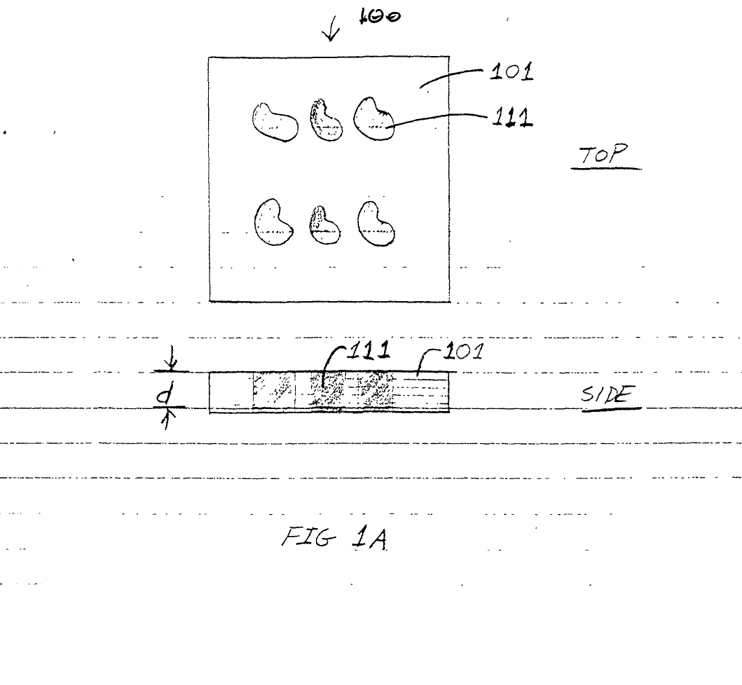

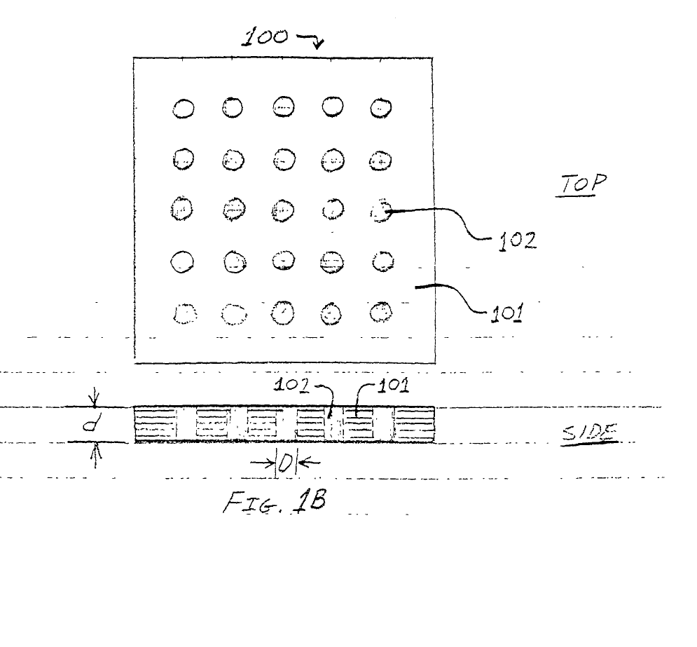

Referring to the drawings in detail, FIG. 1A and FIG. 1B illustrate, in schematic form, the presently preferred first embodiment of the instant invention. Aperture array mask generally indicated as 100 comprises an highly reflective planar dielectric multilayer stack 101 of thickness d with embedded cylindrical dielectrics 111 of arbitrary cross-sections shown in FIG. 1A. The essential feature of embedded cylindrical dielectrics 111 is that each of embedded cylindrical dielectrics 111 supports at least one guided optical mode propagating in a direction perpendicular to the surface of stack 101. A non-limiting example is illustrated in FIG. 1B by circularly cylindrical dielectrics 102 of diameter D arranged in a two-dimensional array.

The array is represented as a simple finite square lattice in FIG. 1B, but it is understood that the array may possess any periodic structure in one or two dimensions. A non-limiting example of a one-dimensional array is illustrated in FIG. 1C wherein cylindrical dielectrics 102 are embedded in multilayer stack 101 at relative positions given by finite repetition of a simple lattice of lattice-vector \vec{a}. Another non-limiting example of a one-dimensional array is illustrated in FIG. 1D: a basis comprising three dielectric cylinders 102A, 102B and 102C is replicated at positions given by finite repetition of lattice-vector \vec{a}.

Two-dimensional arrays are formed by generalizations of one-dimensional arrays. Two-dimensional arrays are described by analogy to well-known principles of crystalline structure. A two-dimensional lattice in the plane of the mask generally indicated as 100 is therefore defined by any pair of non-collinear vectors, \vec{a} and \vec{b}, each of which has nonzero length and is parallel to the surface of the mask generally indicated as 100. The lattice may possess either a simple one-element basis as shown in FIG. 1B or a basis comprising multiple dielectric cylinders of type 102 without departing from the spirit of the instant invention. The lateral extent of the array may also be larger or smaller than the 5×5 array of FIG. 1B without departing from the spirit of the instant invention. Specifically, a finite lattice of dimension {M×N} is formed by repeating a basis comprising one or more dielectric cylinders 102 at all locations m \vec{a}+n\vec{b} for m chosen from the set of the first M natural numbers, {1, 2, . . . , M} and n chosen from the set of the first N natural numbers, {1, 2, . . . , N}. All one-dimensional arrays are then understood to be special cases of two-dimensional arrays, {1×N} or {M×1} for N or M nonzero respectively.

The special case of an arbitrary arrangement of dielectric cylinders of arbitrary cross-sections and indices of refraction, a non-limiting example of which is illustrated in FIG. 1E, is clearly understood to be included in the general definition of a lattice with a basis, supra. Specifically, the special case of an array of dimension {1×1} comprises a single lattice point. Attaching to said lattice point a basis comprising an arbitrary number of dielectric cylinders of arbitrary cross-sections and arbitrary indices of refraction results in a utilitarian structure. Such an arrangement is illustrated in FIG. 1E with dielectric cylinders 103A, 103B, 103C, 103D and 103E.

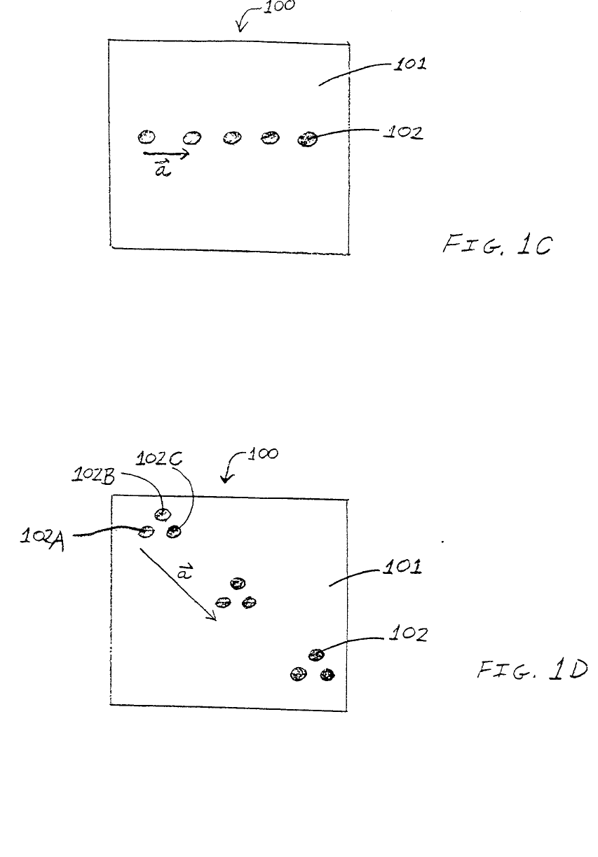

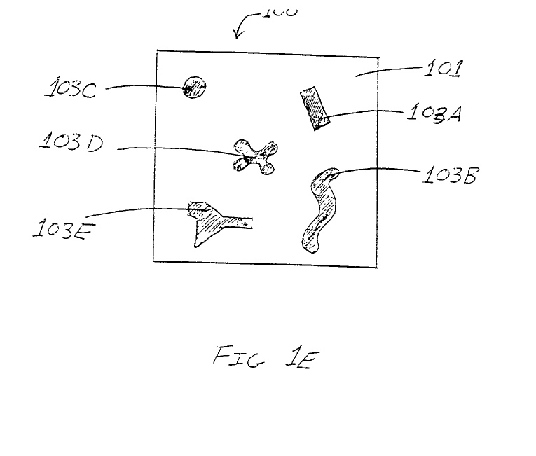

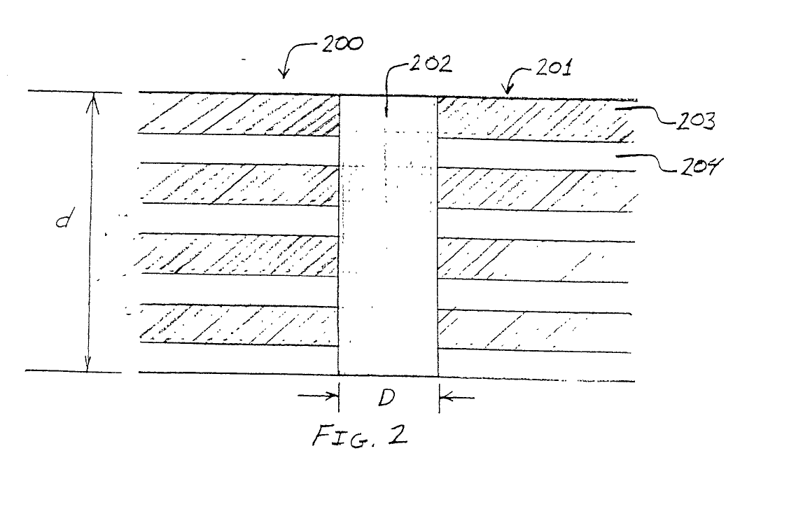

Referring to the drawings in detail, FIG. 2 illustrates, in schematic form, a small section generally indicated as 200 of the mask generally indicated as 100 of the presently preferred first embodiment. The dielectric multilayer stack 201 comprises periodically arranged layers of two or more dielectric materials chosen to produce a desired spectral reflectance characteristic, usually high reflectance over a defined “stop-band” of optical frequencies.

A simple stack of alternating layers 203 and 204 of refractive indices n₁ and n₂, respectively, is shown in FIG. 2 to provide a non-limiting example of an highly reflective dielectric stack. It will be understood by those practiced in the art that other dielectric stacks are possible without departing from the spirit of the instant invention and that the scope of the instant invention includes all multilayer dielectric structures. The thickness d of the mask generally indicated as 200 is determined by the number and types of layers required to achieve a desired reflectance for a particular end-use and may be of the order of a micrometer for optical applications.

The refractive index n₃>max{n₁, n₂} of dielectric circular cylinders 202 such that the resulting structure supports one or more guided electromagnetic modes propagating along the axis of dielectric circular cylinder 202. The diameter D of dielectric circular cylinders 202 is therefore of the order of λ/(2n₃) for an operating wavelength λ measured in vacuum.

We now provide a numerical example to illustrate the manner in which the instant invention derives high spatial resolution. If the operating wavelength is, for example, 633 nm and n₃ is, as for silicon, 3.88, then the lowest-order mode has a spatial extent of approximately 82 nm. The diameter D of dielectric circular cylinders 202 would be made at least 82 nm to support this mode. The resulting spatial resolution which results by coupling this mode to an object-plane in the near-field remains substantially higher than obtainable at the diffraction-limit of approximately λ/2˜316 nm in air.

Moreover, an aperture of index of refraction n₃ and diameter of order of λ/(2n₃) supports at least one guided (i.e., propagating) mode. An aperture of index of refraction n, with n less than n₃, and diameter λ/(2n₃) would, however, support no guided mode; such an aperture would have poor optical transmission and be said to be “cut-off.” The optical throughput of an aperture of diameter λ/(2n₃) and filled with dielectric of index of refraction n₃, is therefore greater than would be realized with an aperture of diameter λ/(2n₃) filled with a dielectric of index of refraction less than n₃, such as air or glass. Thus, the optical throughput of the mask generally indicated as 200 is enhanced by using dielectric cylinders 202 of high index of refraction.

Moreover, the waveguiding structure of FIG. 2 is readily replicated in well-defined arrays such as those of the mask generally indicated as 100 in FIG. 1B. The planar design of the mask generally indicated as 100 in FIG. 1B permits arbitrarily close approach of the mask generally indicated as 100 in FIG. 1B to an object plane.

Moreover, the fixed spatial relationship between dielectric circular cylinders 102 of FIG. 1B provides an important degree of immunity to external mechanical perturbations, even for imperfectly fabricated instances of the mask generally indicated as 100 in FIG. 1B.

A further refinement, implicit in the description of the presently preferred first embodiment, is the capacity to employ one or more higher-order transverse modes of the waveguiding structure of FIG. 2, provided the diameter D of dielectric circular cylinders 202 of FIG. 2 is made sufficiently large to permit efficient transmission at the desired operating wavelength(s), to the extent and degree that different transverse modes interact in measurably distinct fashions with features in an object plane.

Referring to the drawings in detail, FIG. 3A and FIG. 3B illustrate, in schematic form, four non-exclusive, non-limiting nano-machining methods by which aperture array masks generally indicated as 100 of the presently preferred first embodiment may be fabricated. The methods of FIG. 3A and FIG. 3B each involve etching high-aspect-ratio pedestals in, for example, a silicon substrate. The nano-machining may be accomplished by any of several established processes, such as those disclosed in U.S. Pat. No. 5,198,390 and documents cited therein. The resulting pedestals form the dielectric cylinders 102 of the presently preferred first embodiment. The dielectric multilayer stack 101 of the presently preferred first embodiment is then evaporated over the pedestals either directly, as in FIG. 3A, or after a layer of selectively exposed photoresist, as in FIG. 3B.

The direct-evaporation method of FIG. 3A requires a planarizing operation, such as chemical-mechanical polishing, to produce the final structure.

The lift-off method of FIG. 3B uses the same mask as the nano-machining step to expose a layer of resist. The unexposed resist is washed away before evaporating the dielectric multilayer stack 101 of the presently preferred first embodiment. Finally, the exposed resist is lifted off to form the final structure.

The method of FIG. 3C involves milling openings in dielectric multilayer stack 101 of the presently preferred first embodiment by the same or similar nano-machining methods used in FIG. 3A and FIG. 3B. The resulting voids are then backfilled, as for instance by a process such as that disclosed in U.S. Pat. No. 6,030,881 and documents cited therein, with a material of high dielectric constant, such as silicon or silicon nitride. Finally, the excess backfill material is removed by a planarizing operation, such as chemical-mechanical polishing, to produce the final structure.

Referring to the drawings in detail, FIG. 4 illustrates, in schematic form, the presently preferred second embodiment of the instant invention. The mask generally indicated as 400 comprises an highly reflective planar dielectric multilayer stack 401 substantially similar to multilayer stack 101 of the presently preferred first embodiment with embedded circularly cylindrical dielectrics 402A and 402B of diameters D_{A} and D_{B} and refractive indices n_{3A} and n_{3B}>max{nₗ,n₂}, respectively, arranged as a square lattice with a basis. The basis in FIG. 4 comprises one each of dielectric circular cylinders of types 402A and 402B. The general properties of dielectric circular cylinders 402A and 402B are similar to those of dielectric circular cylinders 102 of the presently preferred first embodiment, and the discussion of dielectric circular cylinders 102 of the presently preferred first embodiment applies to each of dielectric circular cylinders 402A and 402B.

Thus, the guided modes of dielectric circular cylinders 402A and 402B can be fabricated to provide discernable spatial resolutions.

The lateral extent of the array may also be larger or smaller than the 5×5 array of FIG. 4 without departing from the spirit of the instant invention. The basis may be made more or less complex than the two-element basis of FIG. 4 without departing from the spirit of the instant invention. Moreover it is understood that the basis may comprise more than two types of dielectric circular cylinders, as for example in support of the seventh advantage, without departing from the spirit of the instant invention.

That the presently preferred fourth embodiment also supports the first through sixth advantages, inclusive, is clear from the foregoing exposition.

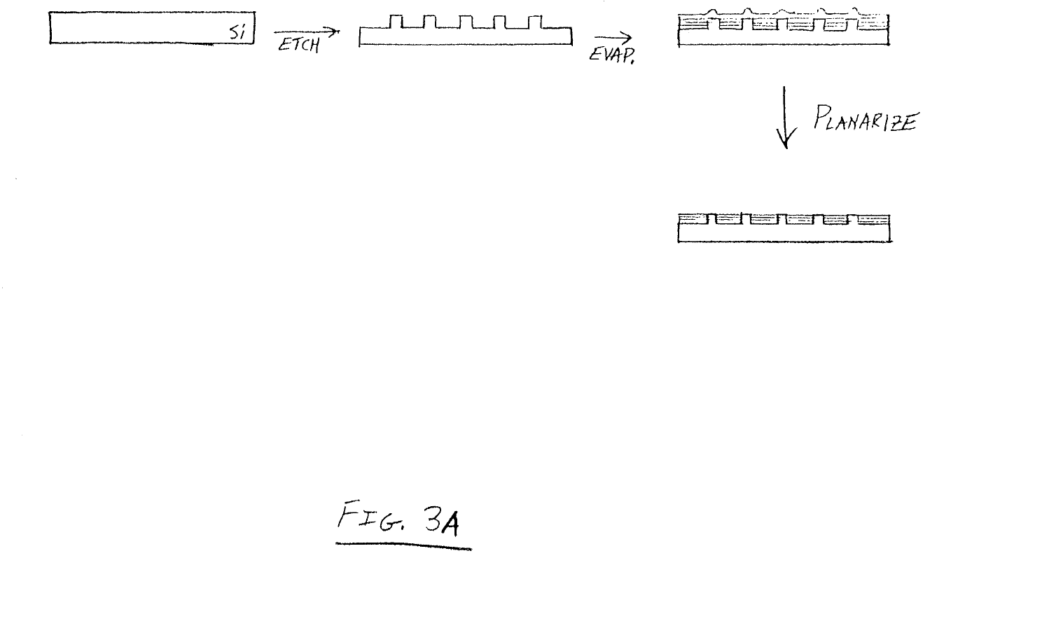

Referring to the drawings in detail, FIG. 5 illustrates, in schematic form, the presently preferred third embodiment of the instant invention. The mask generally indicated as 500 comprises an highly reflective planar dielectric multilayer stack 501 substantially similar to multilayer stack 101 of the presently preferred first embodiment with embedded rectangular cylindrical dielectrics 502 of edge dimensions a and b and refractive index n₃>max{n₁, n₂}.

The resulting rectangular waveguiding structure serves purposes substantially similar to those of dielectric circular cylinders 102 of the presently preferred first embodiment, with one essential exception. Unlike dielectric circular cylinders 102 of the presently preferred first embodiment, which for given indices n₁, n₂ and n₃ support guided propagating modes characterized by a desired operating optical frequency only for diameters larger than a critical “cut-off” diameter, rectangular cylindrical waveguide 502 supports at least one guided propagating mode as either dimension a or b, but not both, is made arbitrarily small. Under these conditions, the smaller of dimensions a or b defines the one-dimensional spatial resolution of the scanning probe. Consequently, high optical throughput can be achieved by maintaining the larger of dimensions a or b comparable to or larger than λ/(2n₃).

A further refinement, implicit in the description of the presently preferred third embodiment, is the capacity to excite one or more higher-order transverse modes of the waveguiding structure of FIG. 5 in support of the sixth advantage, to the extent and degree that different transverse modes interact in identifiably distinct and measurable fashions with features in an object plane. This can be accomplished by providing that at least one of dimensions a or b is made sufficiently large to permit efficient transmission at the desired operating wavelength(s).

The lateral extent of the array may also be larger or smaller than the 2×2 array of FIG. 5 without departing from the spirit of the instant invention.

The basis may be made more or less complex than the one-element basis of FIG. 5 without departing from the spirit of the instant invention.

It is evident that the presently preferred third embodiment also supports the third through fifth advantages, inclusive, in the manner of the presently preferred first embodiment.

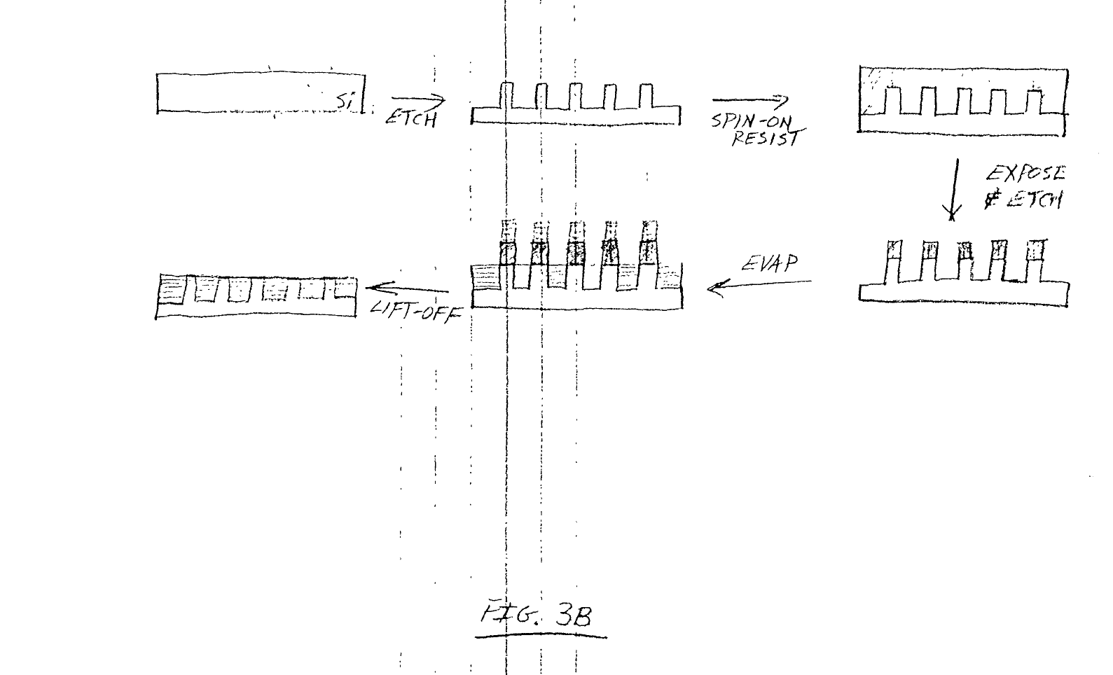

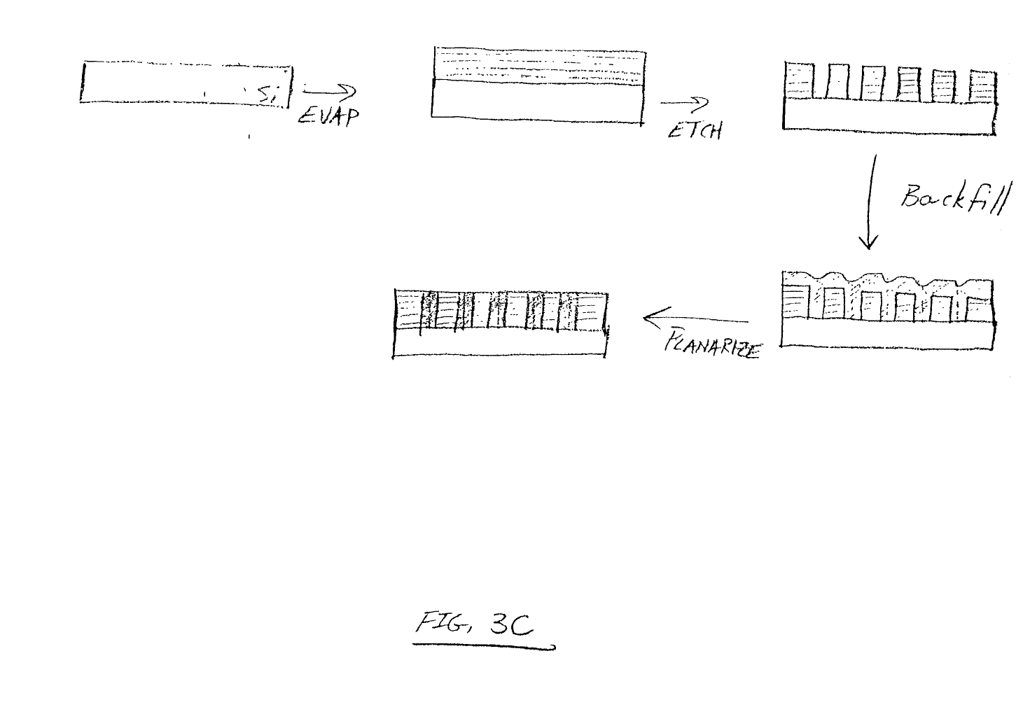

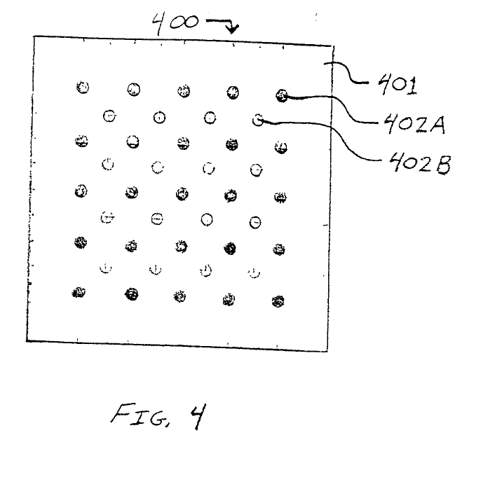

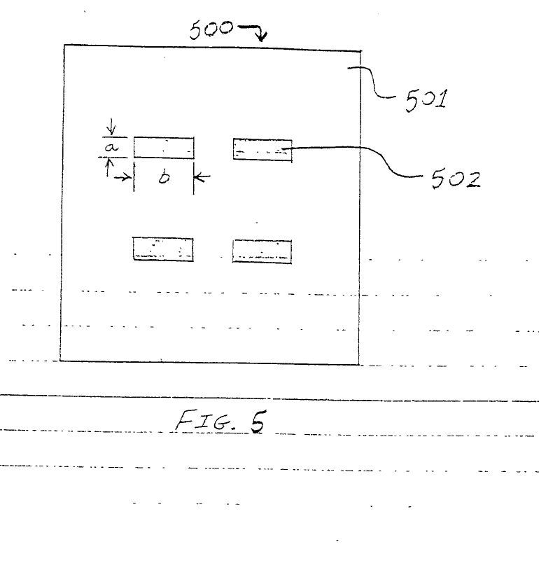

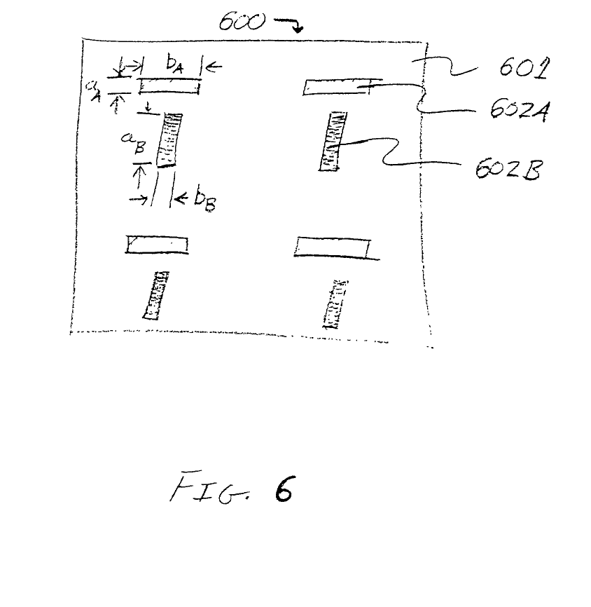

Referring to the drawings in detail, FIG. 6 illustrates, in schematic form, the presently preferred fourth embodiment of the instant invention. Mask 600 comprises an highly reflective planar dielectric multilayer stack 601 substantially similar to multilayer stack 101 of the presently preferred first embodiment with embedded dielectric rectangular cylinders 602A and 602B of edge dimensions a_{A}×b_{A} and a_{B}×b_{B} and refractive indices n_{3A} and n_{3B}>max{n₁, n₂}, respectively, arranged as a square lattice with a basis. The general properties of dielectric rectangular cylinders 602A and 602B are similar to those of dielectric rectangular cylinders 502 of the presently preferred third embodiment and the discussion of dielectric rectangular cylinder 502 of the presently preferred third embodiment applied to each of dielectric rectangular cylinders 602A and 602B.

Thus, the guided modes of dielectric rectangular cylinders 602A and 602B can be fabricated to provide discernable spatial resolutions. For example, dielectric cylinders 602A and 602B may be fabricated with different sizes and/or orientations, to effect sensitivity to different spatial resolutions in a single aperture array.

The lateral extent of the array may also be larger or smaller than the 2×2 array of FIG. 6 without departing from the spirit of the instant invention.

The basis may be made more or less complex than the two-element basis of FIG. 6 without departing from the spirit of the instant invention. Moreover it is understood that the basis may comprise more than two types of dielectric rectangular cylinders, as for example in support of the seventh advantage, without departing from the spirit of the instant invention.

That the presently preferred fourth embodiment also supports the first through sixth advantages, inclusive, is obvious from the foregoing exposition.

Referring to the drawings in detail, FIG. 7 illustrates, in schematic form, the presently preferred fifth embodiment of the instant invention. The mask generally indicated as 700 comprises an highly reflective planar dielectric multilayer stack 701 substantially similar to multilayer stack 101 of the presently preferred first embodiment with embedded dielectric cylinders 702A, 702B, and 702C forming a three-element basis arranged on a 2×2 square lattice. Rectangular dielectric cylinders 702A and 702B have dimensions a_{A}×b_{A} and a_{B}×b_{B} and refractive indices n_{3A} and n_{3B}>max{n₁, n₂}, respectively. Dielectric circular cylinder 702C has diameter D_{C} and refractive index n_{3C}>max{n₁, n₂}.

Thus the guided modes of dielectric cylinders 702A, 702B and 702C can be fabricated to provide discernable spatial resolutions.

The relative orientations of dielectric cylinders 702A and 702B inform a non-limiting example by which the description of a dielectric cylinder not possessing complete two-dimensional rotational symmetry includes specification of the orientation of said dielectric cylinder. The lateral extent of the array may also be larger or smaller than the 2×2 array of FIG. 7 without departing from the spirit of the instant invention.

The basis may be made more or less complex than the three-element basis of FIG. 7 without departing from the spirit of the instant invention.

Moreover it is understood that the basis may comprise more or fewer than three types of dielectric rectangular cylinders, as for example in support of the seventh advantage, without departing from the spirit of the instant invention.

That the presently preferred fourth embodiment also supports the sixth through sixth advantages, inclusive, is obvious from the foregoing exposition.

Referring to the drawings in detail, FIG. 8A and FIG. 8B illustrate, in schematic form, the presently preferred sixth embodiment of the instant invention. The mask generally indicated as 800 comprises an highly reflective planar dielectric multilayer stack 801 substantially similar to multilayer stack 101 of the presently preferred first embodiment, with embedded dielectric cylinders 802, save for the addition of an absorbing or reflecting interlayer 805.

It is understood that the type and arrangement of dielectric cylinders 802 is not limited to the geometry of FIG. 8A and may be any instance described by any of the several preferred embodiments documented herein.

Absorbing or reflecting interlayer 805 may lie above or below any dielectric layer 803 or 804 and is advantageously placed on that mask surface which will be placed nearest the object-plane, as shown in FIG. 8A, where absorbing or reflecting interlayer 805 serves to improve the effective resolution of the aperture array by attenuating the evanescent component(s) of the guided mode(s) of a dielectric cylinder 802. Specifically, by attenuating evanescent component(s), the effective spatial resolution in the near-field of the aperture is defined chiefly by the geometry of the aperture rather than the spatial extent of the evanescent component(s). The thickness of absorbing or reflecting interlayer 805 is therefore of the order of one or more times the skin-depth of light of the operating wavelength in the absorbing or reflecting interlayer. A non-limiting example of an absorbing or reflecting interlayer is a metal.

Absorbing or reflecting interlayer 805 may also be advantageously placed between dielectric layers near that mask surface which will be placed nearest the object-plane, as shown in FIG. 8B, where absorbing or reflecting interlayer 805 serves to improve the effective resolution of the aperture array by attenuating the evanescent component(s) of the guided mode(s) of a dielectric cylinder 802. Specifically, by attenuating evanescent component(s), the effective spatial resolution in the near-field of the aperture is defined chiefly by the geometry of the aperture rather than the spatial extent of the evanescent component(s). The embodiment of FIG. 8B is therefore advantageous over the embodiment of FIG. 8A inasmuch as the potential for interaction between the absorbing or reflecting interlayer and materials in or near the object-plane is reduced, in direct support of the tenth advantage. This is achieved by “burying” the absorbing or reflecting interlayer 805 behind a screening dielectric 806, which may or may not be identical to either dielectric layer 803 or 804. The criteria for choosing the dimensions of absorbing or reflecting interlayer 805 are the same for the embodiment of FIG. 8B as for the embodiment of FIG. 8A.

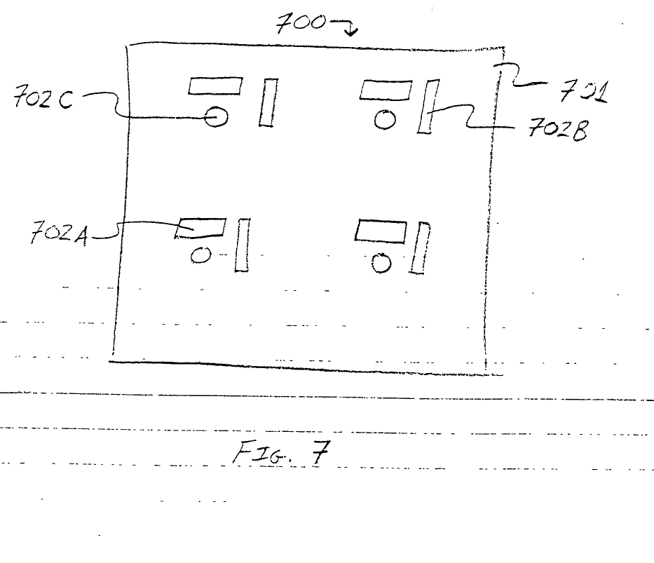

Referring to the drawings in detail, FIG. 9A and FIG. 9B illustrate, in schematic form, the presently preferred seventh embodiment of the instant invention. The mask generally indicated as 900 comprises an highly reflective planar dielectric multilayer stack 901 substantially similar to multilayer stack 101 of the presently preferred first embodiment, with embedded dielectric cylinders 902, save for the addition of an absorbing or reflecting interlayer pads 905. It is understood that the type and arrangement of dielectric cylinders 902 is not limited to the geometry of FIG. 9A and may be any instance described by any of the several preferred embodiments documented herein.

Absorbing or reflecting interlayer pads 905 may lie above or below any dielectric layer 903 or 904 and are advantageously placed on that mask surface which will be placed nearest the object-plane, as shown in FIG. 9A, where absorbing or reflecting interlayer pads 905 serve to improve the effective resolution of the aperture array by attenuating the evanescent component(s) of the guided mode(s) of a dielectric cylinder 902. Specifically, by attenuating evanescent component(s), the effective spatial resolution in the near-field of the aperture is defined chiefly by the geometry of the aperture rather than the spatial extent of the evanescent component(s). The thickness of absorbing or reflecting interlayer pads 905 is therefore of the order of one or more times the skin-depth of light of the operating wavelength in the absorbing or reflecting interlayer. A non-limiting example of an absorbing or reflecting interlayer pad is a metal. The lateral extent s of the absorbing or reflecting interlayer pads 905 is of the order of the characteristic lateral extent of the evanescent component(s) of the guided mode(s). The minimum separation g between the perimeters of any two absorbing or reflecting interlayer pads 905 is chosen sufficient to electronically decouple all absorbing or reflecting interlayer pads 905. Specifically, the separation g can be chosen sufficient to suppress plasmon oscillations involving any two or more absorbing or reflecting interlayer pads 905.

Absorbing or reflecting interlayer pads 905 may also be advantageously placed between dielectric layers 903 and 904 near that mask surface which will be placed nearest the object-plane, as shown in FIG. 9B, where absorbing or reflecting interlayer pads 905 serve to improve the effective resolution of the aperture array by attenuating the evanescent component(s) of the guided mode(s) of a dielectric cylinder 902, as described in the preceding paragraph and FIG. 9A. The embodiment of FIG. 9B is advantageous over the embodiment of FIG. 9A inasmuch as the potential for interaction between the absorbing or reflecting interlayer and materials in or near the object-plane is reduced in support of the tenth advantage. This is achieved by “burying” the absorbing or reflecting interlayer 905 behind a screening dielectric 906, which may or may not be identical to either dielectric layer 903 or 904. The criteria for choosing the dimensions and separations of absorbing or reflecting interlayer pads 905 are the same for the embodiment of FIG. 9B as for the embodiment of FIG. 9A.

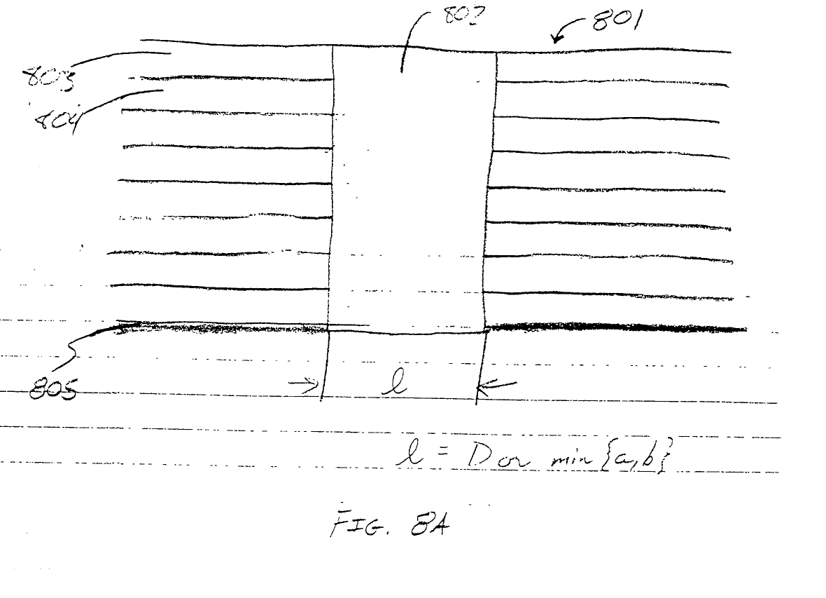

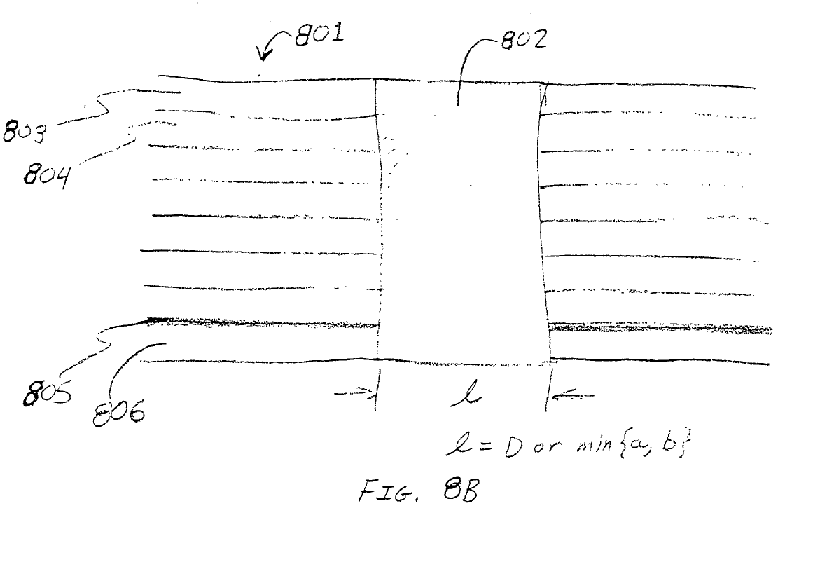

Referring to the drawings in detail, FIG. 10A and FIG. 10B illustrate, in schematic form, the presently preferred eighth embodiment of the instant invention. Aperture array 1001 is of any of the types described by the preferred embodiments first through seventh documented herein and is fabricated directly on a flat optical substrate 1002 in FIG. 10A. Aperture array 1001 is fabricated directly on an optical substrate 1002 in FIG. 10A. Optical substrate 1003 of FIG. 10B is figured to implement light-gathering or focusing as required for particular end-uses, in support of the eighth advantage. Both types optical substrates 1002 and 1003 provide a mechanically stable platform for fabrication and mounting of aperture array 1001.

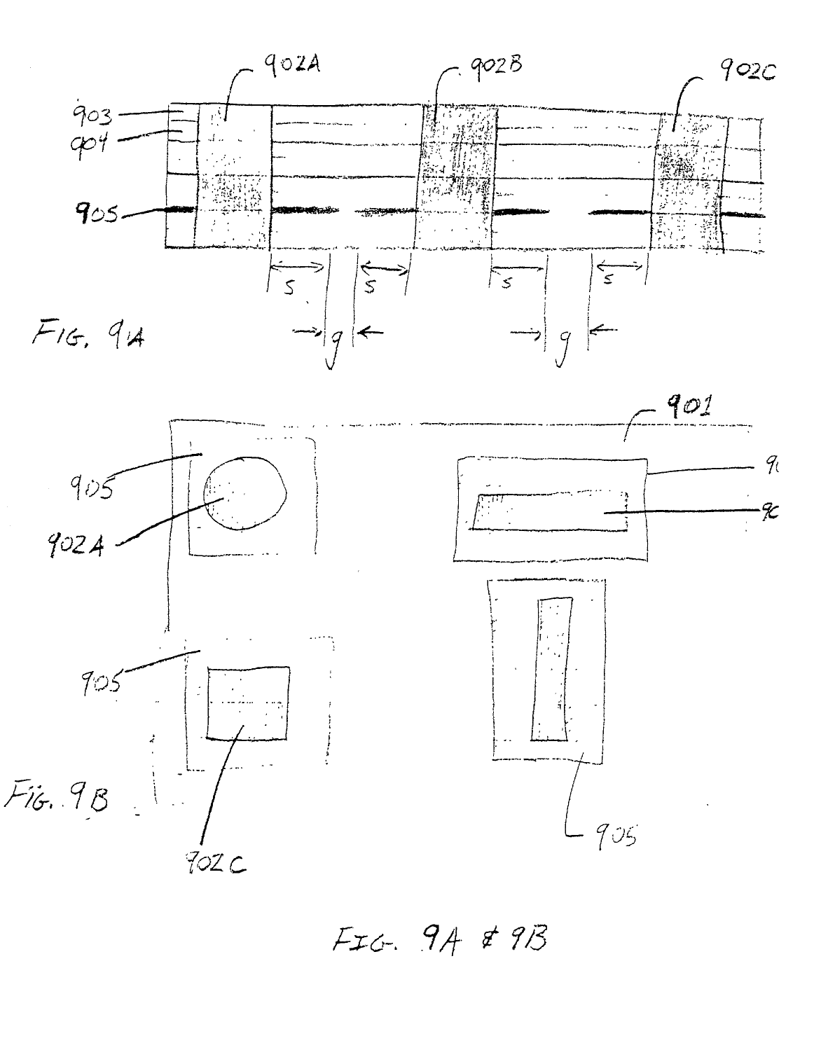

Referring to the drawings in detail, FIG. 11 illustrates, in schematic form, the presently preferred ninth embodiment of the instant invention. Aperture array mask 1101 is fabricated or otherwise mounted on optical substrate 1103 described in the presently preferred eighth embodiment. Aperture array 1101 is illuminated through optical substrate 1103 by a traveling wave 1104 described by principal wavevector \vec{k} making an angle of incidence θ between \vec{k} and surface-normal \vec{n} and an angle φ between a fixed but arbitrary vector \vec{X} perpendicular to surface normal \vec{n} and the projection \vec{k}_{∥}of \vec{k} on a plane parallel to \vec{X}. The apertures 1102 of aperture array mask 1101 so illuminated are simultaneously excited to the extent that the traveling wave mode profile is congruent with the mode(s) guided by the individual apertures 1102. The apertures 1102 are thereby illuminated with systematically varying phases for any angle θ not equal to zero. The character of the resulting transmission of light from the apertures 1102 is well known to those practiced in the art as a “phased array” with utility also well known to those practiced in the art. Moreover, the orientation of this phased array may be rotated in a plane either by rotating mask 1101 and substrate 1102 together or by rotating \vec{k} about \vec{n} to effect a change in angle φ.

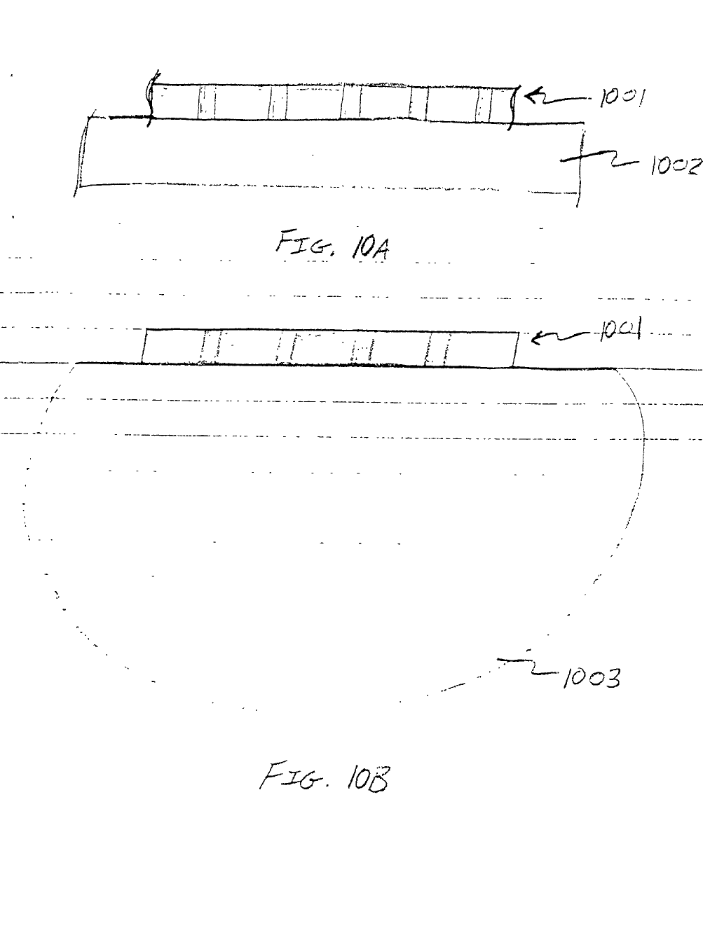

Referring to the drawings in detail, FIG. 12 illustrates, in schematic form, the presently preferred tenth embodiment of the instant invention. Aperture array mask 1201 is fabricated or otherwise mounted on optical substrate 1203 as described in the presently preferred eighth embodiment.

Aperture array 1201 is illuminated through optical substrate 1203 by a standing-wave intensity-pattern 1204 described by period and contours of equal amplitude making an angle π/2-φ between a fixed but arbitrary vector X perpendicular to surface normal \vec{n}. Standing-wave intensity-pattern 1204 may be produced by any of the interferometric or holographic methods well known to those practiced in the art. The apertures 1202 of aperture array mask 1201 so illuminated are simultaneously excited to the extent that the standing-wave mode-profile is congruent with the mode(s) guided by the individual apertures 1202. The apertures 1202 are thereby excited to the extent that the antinodes of the standing-wave pattern overlap apertures 1202.

Hence, the number and spacing of excited apertures may be controlled to purpose either (i) by rotating mask 1201 and substrate 1202 together in support of the sixteenth advantage or (ii) by rotating standing-wave pattern 1204 about \vec{n} to effect a change in angle φ in support of the sixteenth advantage or (iii) by changing the period of the standing-wave pattern.

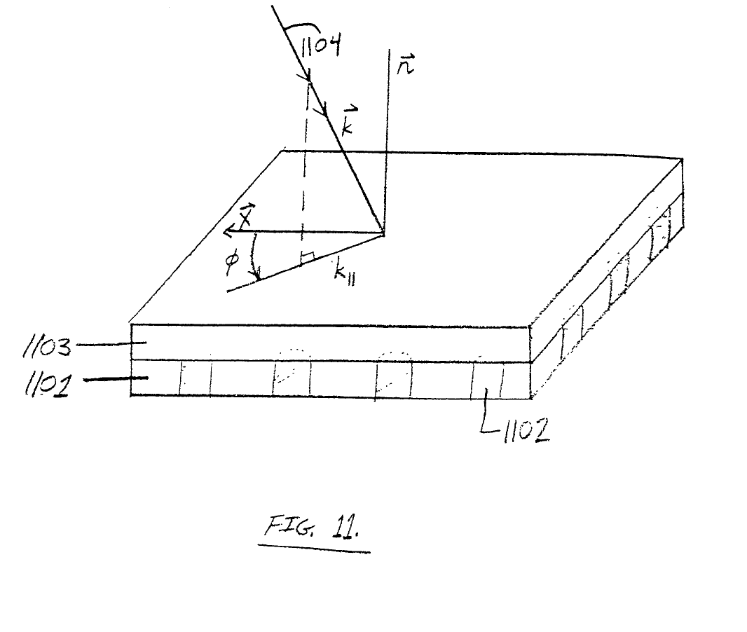

Referring to the drawings in detail, FIG. 13 illustrates, in schematic form, the presently preferred eleventh embodiment of the instant invention. Composite aperture array mask 1301 is fabricated or otherwise mounted on optical substrate 1303 described in the presently preferred eighth embodiment. Composite aperture array 1301 comprises two or more aperture arrays of types described in presently preferred first through seventh embodiments, each with independent lattice and basis specifications, combined in a single aperture array.

Aperture array 1301 is illuminated through optical substrate 1303 by a standing-wave intensity-pattern 1304 described by period p and contours of equal amplitude making an angle π/2-φ between a fixed but arbitrary vector \vec{X} perpendicular to surface normal \vec{n}. Standing-wave intensity-pattern 1304 may be produced by any of the interferometric or holographic methods well known to those practiced in the art. The apertures 1302 of aperture array mask 1301 so illuminated are simultaneously excited to the extent that the standing-wave mode-profile is congruent with the mode(s) guided by the individual apertures 1302. The apertures 1302 are thereby excited to the extent that the antinodes of the standing-wave pattern overlap apertures 1302.

Hence, the number and spacing of excited apertures may be further controlled to purpose either (i) by rotating mask 1301 and substrate 1303 together to effect a change in angle φ in support of the sixteenth advantage or (ii) by rotating standing-wave pattern 1304 about \vec{n} to effect a change in angle φ in support of the sixteenth advantage or (iii) by changing the period of the standing-wave pattern.

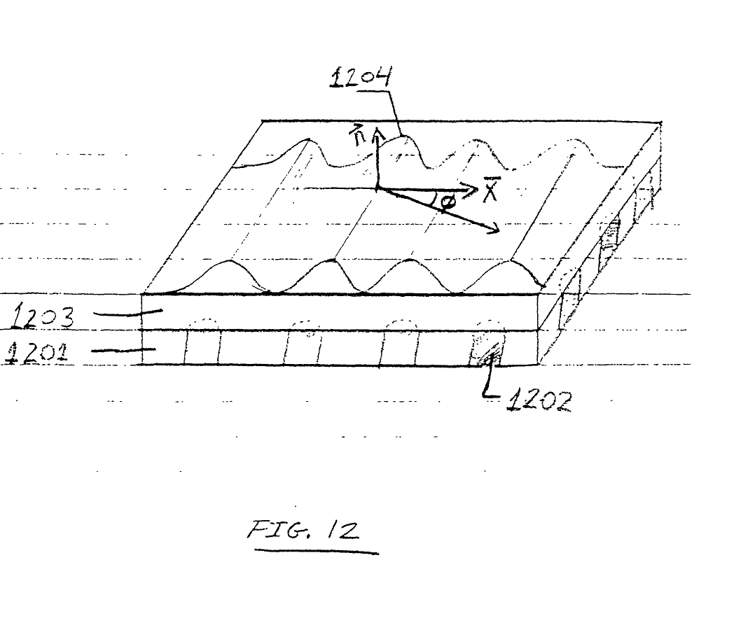

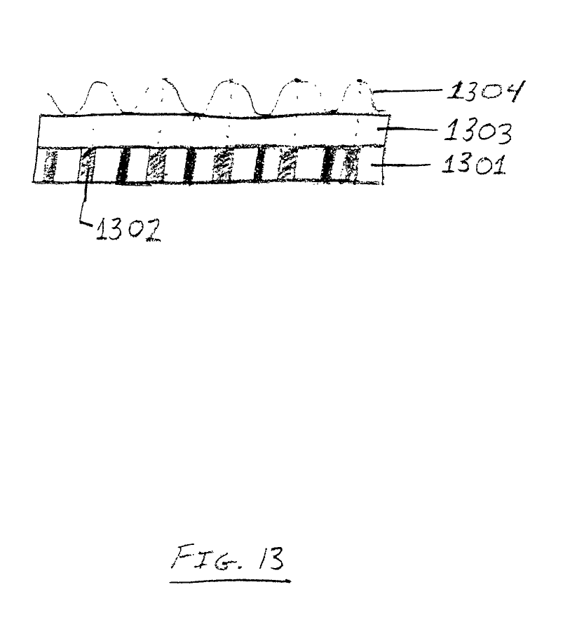

Referring to the drawings in detail, FIG. 14A and FIG. 14B illustrate, in schematic form, the presently preferred twelfth embodiment of the instant invention. The presently preferred twelfth embodiment can be understood as a simplification of the presently preferred sixth embodiment. Mask 1400 comprises a dielectric plate 1401, with embedded dielectric cylinders 1402 and reflecting layer 1405. It is understood that the type and arrangement of dielectric cylinders 1402 is not limited to the geometry of FIG. 14A and may be any instance described by any of the several preferred embodiments documented herein. Reflecting layer 1405 is advantageously placed on that mask surface which will be placed nearest the object-plane, as shown in FIG. 14A, wherein reflecting layer 1405 serves to improve the effective resolution of the aperture array by reflecting the evanescent component(s) of the guided mode(s) of a dielectric cylinder 1402. The thickness of reflecting layer 1405 is therefore of the order of one or more times the skin-depth of light of the operating wavelength in the reflecting interlayer. A non-limiting example of a reflecting interlayer is a metal.

Reflecting layer 1405 may also be advantageously placed between dielectric layers near that mask surface which will be placed nearest the object-plane, as shown in FIG. 14B, where reflecting layer 1405 serves to improve the effective resolution of the aperture array by attenuating the evanescent component(s) of the guided mode(s) of a dielectric cylinder 1402. The embodiment of FIG. 14B is advantageous over the embodiment of FIG. 14A inasmuch as the potential for interaction between the reflecting layer and materials in or near the object-plane is reduced in support of the tenth advantage. This is achieved by “burying” the reflecting layer 1405 behind a screening dielectric 1406, which may or may not be identical in composition to dielectric plate 1401. The criteria for choosing the thickness of reflecting layer 1405 are the same for the embodiment of FIG. 14B as for the embodiment of FIG. 14A.

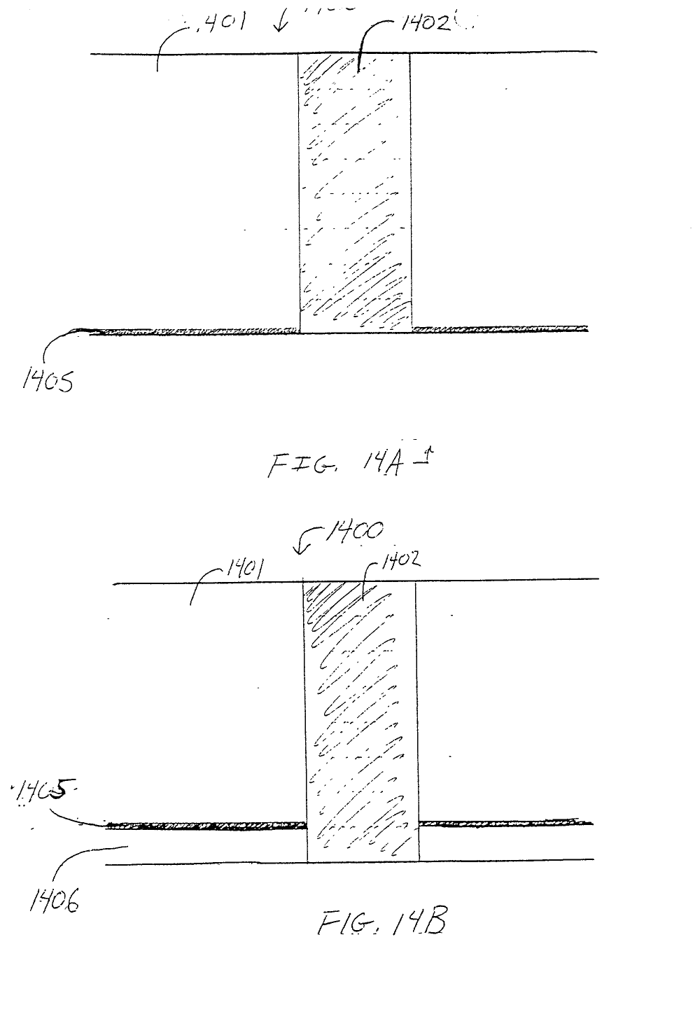

Referring to the drawings in detail, FIG. 15 illustrates, in schematic form, the presently preferred thirteenth embodiment of the instant invention. Mask structure 1500 may be any of the several presently preferred embodiments described elsewhere herein. The essential feature of mask 1500, for the discussion of the presently preferred thirteenth embodiment, is the presence of dielectric cylinders 1502 possessing index of refraction n₃.

Dielectric layer 1590 has the same index of refraction n₃ as dielectric cylinders 1502. Dielectric layer 1590 thus facilitates matching of the transverse mode profile of an illuminating source to the guided modes concentrated in dielectric cylinders 1502.

Antireflection structure 1591 is designed to minimize or eliminate reflection losses for light incident on the mask through antireflection structure 1591. The particular symmetries of Maxwell's equations provide that the same structure simultaneously minimizes or eliminates reflection losses for light originating at the mask 1500 and conveyed through antireflection structure 1591. Antireflection structure 1591 can be interpreted as an optical “impedance-matching” device ensuring maximal transfer of optical power from to and from the mask 1500. The means to manufacture such antireflection structures 1591 are well known to those practiced in the art.

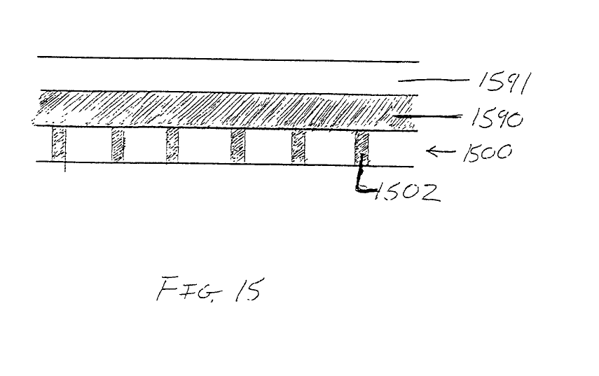

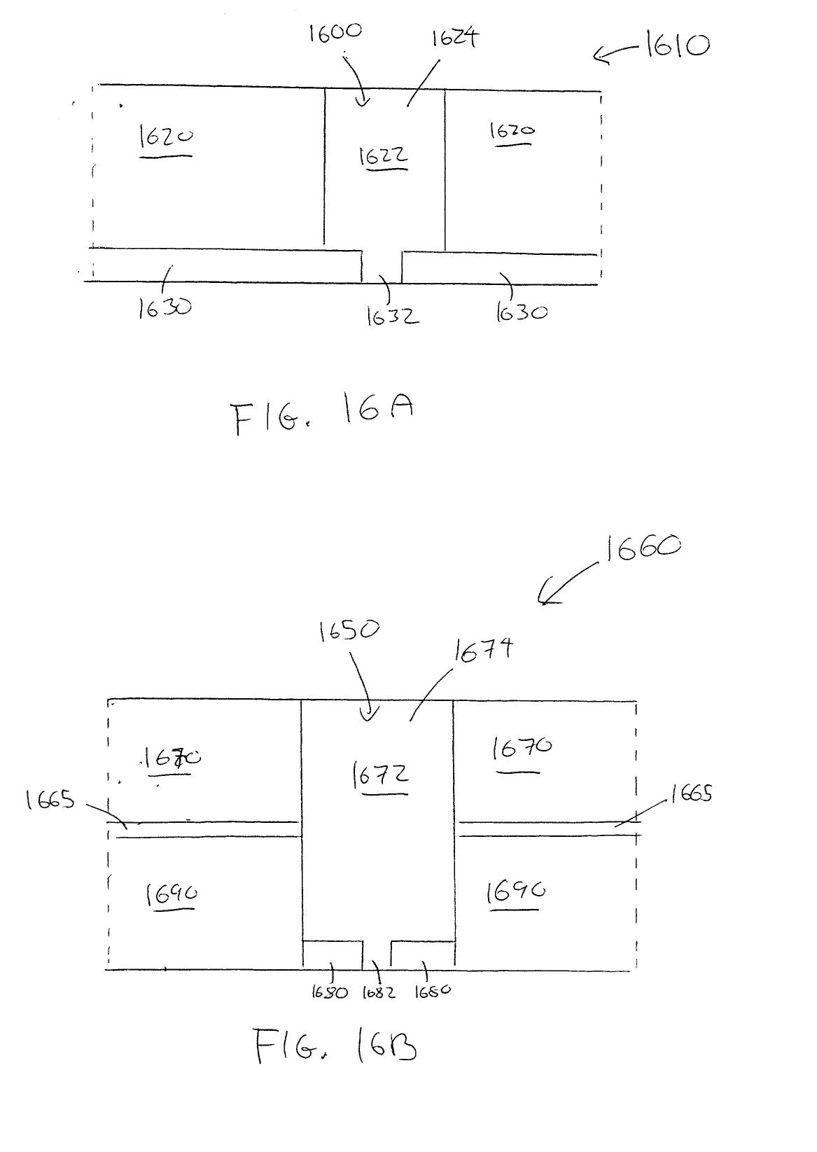

Any of the previously described embodiments of the mask may further include an end mask portion that provides with one or more sub-wavelength, secondary apertures at the end of each waveguide to further improve the spatial resolution of the source array. An aperture element for one such embodiment is shown schematically in FIG. 16A.

Source array mask 1610 includes a reflective dielectric stack 1620 and an end mask portion 1630 having an array of secondary apertures 1632. Each mask aperture 1600 includes a waveguide 1622 formed by a dielectric material 1624 extending through dielectric stack 1620 and the secondary aperture 1632. Moreover, in some embodiments the end mask portion may provide more than one secondary aperture for with each waveguide. As described above, dielectric stack 1620 may be formed by alternating layers (not shown) of dielectric material having refractive indices n₁ and n₂. Furthermore, dielectric material 1624 forming waveguide 1622 may have a refractive index n₃, such that n₃>n₁ and n₃>n₂. End mask portion 1630 may be formed by a metal layer, and secondary aperture 1632 may be selected to be a sub-wavelength aperture. In other words, secondary aperture may have a transverse dimension smaller than that necessary to support a propagating mode in dielectric material 1624.

In the embodiment shown in FIG. 16A, end mask portion 1630 forms an interface with both dielectric stack 1620 and waveguide 1622. In other embodiments, the end mask portion may form an interface primarily with waveguide 1622, and have a limited lateral extent along reflective dielectric stack 1620. One such embodiment is shown for source array mask 1660 in FIG. 16B. Like mask 1610, mask 1660 includes a reflective dielectric stack 1670 surrounding an array of apertures 1650. Mask 1610 further includes an end mask portion 1680 having an array of secondary apertures 1682. Each mask aperture 1650 includes a waveguide 1672 formed by a dielectric material 1674 extending through dielectric stack 1670 and secondary aperture 1682. End mask portion 1680 extends along the width of each dielectric material 1624.

Furthermore, to suppress multiple reflections between the object and the surface of mask 1660 nearest the object, mask 1660 may further include an anti-reflection layer 1690 formed on the surface of mask 1660 nearest the object. For example, the anti-reflection layer 1690 may surround end mask portion 1680 and waveguide 1682 as shown in FIG. 16B. The anti-reflection layer 1690 may be formed by some combination of dielectric and/or metal layers. Moreover, mask 1660 may further include a metal layer 1665 sandwiched between dielectric stack 1670 and anti-reflection layer 1690 to minimize their interaction between.

One example of a suitable series of layers for the anti-reflection coating is as follows: a first 51 nm layer of silicon dioxide, a second layer 6 nm layer of Beryllium, a third 51 nm layer of silicon dioxide, followed by a fourth 50 nm layer of Aluminum on a silicon dioxide substrate, wherein the coating is designed to prevent reflections from an interface between the first layer and air.

Also, either of waveguides 1622 and 1672 in the respective masks may be designed to form a cavity between opposite sides of the mask. In such cases, the length of the waveguide is selected to cause the cavity to be resonant, or at least substantially resonant, at the wavelength of the radiation.

Any of the embodiments described above may further include a source for providing radiation, wherein the array of mask apertures is positioned to receive the radiation and radiate a portion of the radiation to an object through each aperture.

Other aspects, advantages, and modifications are within the scope of the following claims.

What is claimed is:

1. A multiple-source array for illuminating an object, the multiple source array comprising:
a source of electromagnetic radiation having a wavelength λ in vacuum; and
a reflective mask positioned to receive the electromagnetic radiation, the reflective mask comprising an array of spatially separated apertures, wherein each aperture comprises a dielectric material defining a waveguide having transverse dimensions sufficient to support one or more guided propagating modes of the electromagnetic radiation extending through the mask, each aperture configured to radiate a portion of the electromagnetic radiation to the object.

2. The multiple source array of claim 1, wherein the reflective mask further comprises a reflective dielectric stack surrounding the array of apertures.

3. The multiple source array of claim 1, wherein the mask further comprises an end mask portion positioned adjacent the object, and wherein each aperture further comprises a secondary aperture formed in the end mask portion and aligned with the corresponding waveguide, wherein each secondary aperture has a transverse dimension smaller than the transverse dimensions of the corresponding waveguide.

4. The multiple source array of claim 3, wherein the transverse dimension of each secondary aperture is smaller than the vacuum wavelength of the electromagnetic radiation provided by the source.

5. The multiple source array of claim 3, wherein the mask further comprises a reflective dielectric stack surrounding each of the waveguides.

6. The multiple source array of claim 5, wherein the end mask portion comprises a metal layer.

7. The multiple source array of claim 3, wherein each waveguide defines an optical cavity between opposite sides of the mask, and wherein the length of each waveguide is selected to cause the optical cavity to be resonant with the electromagnetic radiation.

8. The multiple source array of claim 2, wherein the reflective mask further comprises an antireflection coating positioned adjacent the object.

9. The multiple source array of claim 1, wherein at least some of the apertures are substantially cylindrical and the cylindrical apertures have a diameter on the order of λ/2n₃, where n₃ is the refractive index of the dielectric material in each corresponding aperture.

10. The multiple source array of claim 1, wherein at least one of the transverse dimensions of each aperture is on the order of λ/2n₃, where n₃ is the refractive index of the dielectric material in each corresponding aperture.

11. The multiple source array of claim 10, wherein another of the transverse dimensions of at least one of the apertures is smaller than λ/2n₃.

12. The multiple source array of claim 1, wherein at least some of the apertures in the reflecting mask define a periodic array.

13. The multiple source array of claim 12, wherein the periodic array comprises a multi-aperture basis.

14. The multiple source array of claim 1, wherein the apertures comprise a first set of apertures having properties sufficient to support a first set of one or more guided propagating modes of the electromagnetic radiation extending through the mask and a second set of apertures having properties sufficient to support a second set of one or more guided propagating modes of the electromagnetic radiation extending through the mask, wherein the first set of one or more guided propagating modes differs from the second set of one or more guided propagating modes.

15. The multiple source array of claim 14, wherein the first set of apertures define a first periodic array of apertures and the second set of apertures define a second period array of apertures.

16. The multiple source array of claim 1, wherein the dielectric material in at least one of the apertures is silicon.

17. The multiple source array of claim 1, wherein the wavelength λ is an optical wavelength.

18. The multiple source array of claim 1, wherein the source directs the electromagnetic radiation to contact the reflective mask at an angle with respect to a normal axis for the mask.

19. The multiple source array of claim 1, wherein the source directs the electromagnetic radiation to contact the reflective mask as a standing wave pattern.

20. The multiple source array of claim 2, wherein the reflective dielectric stack comprises alternating layers of different dielectric materials.

21. The multiple source array of claim 20, wherein the refractive indices of the dielectric materials in the alternating layers are smaller than the refractive index of the dielectric material in each aperture.

22. The multiple source array of claim 2, wherein the reflective mask further comprises a reflective/absorbing layer positioned to attenuate evanescent components of the guided propagating modes extending away from the apertures.

23. The multiple source array of claim 22, wherein the reflective/absorbing layer is a metal layer.

24. The multiple source array of claim 22, wherein the reflective/absorbing layer has thickness greater than the skin depth of the electromagnetic radiation for the reflective/absorbing layer material.

25. The multiple source array of claim 22, wherein the reflective/absorbing layer is positioned on one side of the dielectric stack.

26. The multiple source array of claim 22, wherein reflective mask further comprises a dielectric screening layer, and wherein the reflective/absorbing layer is positioned between the dielectric screening layer and the dielectric stack.

27. The multiple source array of claim 22, wherein the reflective/absorbing layer is formed by a series of pads in a common plane, wherein adjacent pads are spaced from one another by an amount sufficient to suppress plasmon oscillations in the reflective/absorbing layer.

28. The multiple source array of claim 1, further comprising an optical substrate attached to the reflective mask, wherein the optical substrate is substantially transparent to the electromagnetic radiation.

29. The multiple source array of claim 28, wherein the optical substrate provides mechanical stability to the reflective mask.

30. The multiple source array of claim 28, wherein the optical substrate comprises a curved surface to provide light gathering or focusing.

31. The multiple source array of claim 1, further comprising a uniform dielectric layer formed over the reflective mask, wherein the dielectric material in the apertures and the dielectric layer formed over the mask comprise a common dielectric material.

32. The multiple source array of claim 31, further comprising an anti-reflection coating formed over the uniform dielectric layer.

33. A multiple-source array for illuminating an object with electromagnetic radiation having a wavelength λ in vacuum, the multiple-source array comprising:
a reflective mask comprising an array of spatially separated apertures, wherein each aperture comprises a dielectric material defining a waveguide having transverse dimensions sufficient to support one or more guided propagating modes of the electromagnetic radiation extending through the mask, each aperture configured to radiate a portion of the electromagnetic radiation to the object.

34. A method for illuminating an object with electromagnetic radiation having a wavelength λ in vacuum, the method comprising:
providing a mask comprising an array of waveguides; and
coupling a portion of the electromagnetic radiation through each waveguide to illuminate different spatial regions of the object.
